(19) United States
(12) Patent Application Publication
(10) Pub. No.: US 2008/0269086 A1
(43) Pub. Date: Oct. 30, 2008

(54) Functionalized nanosphere lubricants

(76) Inventor: Atanu Adhvaryu, Peoria, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/796,791

(22) Filed: Apr. 30, 2007

(51) Int. Cl. C08G 8/00; C08G 8/04

(52) U.S. Cl. 508/155; 508/166; 508/167

(57) ABSTRACT

A method of making a lubricant is disclosed. The method includes providing a hard nanosphere having a size of less than about 500 nanometers. The method also includes exposing the nanosphere to a radiation energy to at least partially bond a functional agent to a surface of the nanosphere.

### TECHNICAL FIELD

The present disclosure relates generally to lubricants and, more particularly, to functionalized nanosphere lubricants.

### BACKGROUND

A lubricant is a substance, often a liquid, introduced between two moving surfaces to reduce friction or wear between the two surfaces. Liquid lubricants function by transferring forces between opposing surfaces via fluid pressure, while solid lubricants function by reducing contact or friction between opposing surfaces. Lubricants are widely used to maintain and prolong the operational life of moving parts in various dynamic systems, such as, for example, engines, gears, and hydraulics.

Different types of lubrication can be broadly defined based on the mechanism of lubricant operation. These types include hydrodynamic lubrication, mixed lubrication, boundary lubrication, and enhanced pressure lubrication. Hydrodynamic and mixed lubrication maintain separation of moving surfaces by, respectively, a thick film and a thin film of lubricant. Boundary layer and enhanced pressure types of lubrication use a thin solid layer of the lubricant formed on the surfaces of the moving parts. In some cases, this thin layer of solid lubricant can be formed by material sheared off larger lubricant particles or products of reacted additives contained within a fluid lubricant.

Nanosphere lubricants are nanometer-sized spheres configured to provide chemically or physically stable lubrication between moving surfaces. Nanospheres can reduce friction between the surfaces by functioning as tiny balls in a “bearing” between the moving surfaces. The lubricity of nanospheres is due in part to the curvature and small size of the nanospheres. In contrast with spherical particles of larger dimension, the small size of nanospheres does not generally affect the separation between the moving surfaces.

One application of a nanoparticle based lubricant is described in U.S. Patent Application Publication No. 2007/0004602 (hereinafter “the '602 publication”) of Waynick, published on Jan. 4, 2007. The '602 publication generally describes nanoparticulate additives for use in oils and greases. The additives can include a carbonate, such as calcium carbonate, a carboxylate, a phosphate, a sulfate, or a combination of two or more of these materials. The '602 publication describes the use of combinations of these various materials to achieve superior results than using these materials alone.

Although the '602 publication describes a range of nanoparticulate additives, limitations remain. For instance, surface chemical reactivity of the nanoparticles may be high, which could lead to unwanted particle aggregation, increasing effective particle size and reducing advantages of the nanoparticle's small dimensions. In addition, the chemical composition of the nanoparticles may not permit formation of a lubricant with chemical properties suitable to resist corrosion or wear.

The present disclosure is directed at overcoming one or more of the shortcomings of the prior nanoparticle lubricants.

### SUMMARY OF THE INVENTION

In one aspect, the present disclosure is directed toward a method of manufacturing a lubricant. The method includes providing a hard nanosphere having a size of less than about 500 nanometers. The method also includes exposing the nanosphere to a radiation energy to at least partially bond a functional agent to a surface of the nanosphere.

In another aspect, the present disclosure is directed toward a lubricant including a hard nanosphere having a dimension of less than about 500 nanometers. The lubricant also includes a functional agent at least partially bonded to a surface of the nanosphere by radiation energy.

In yet another aspect, the present disclosure is directed toward a lubricant. The lubricant includes a base oil and a lubricant additive. The lubricant also includes a ceramic nanosphere having a size less than about 500 nanometers and a functional agent at least partially bonded to a surface of the nanosphere by microwave energy.

### BRIEF DESCRIPTION OF THE DRAWINGS

The accompanying drawings, which are incorporated in and constitute a part of this specification, illustrate exemplary embodiments of the disclosure and, together with the written description, serve to explain the principles of the disclosed system.

FIG. 1 illustrates two surfaces moving relative to one another and including a lubricant, according to an exemplary disclosed embodiment.

FIG. 2 illustrates an enlarged view of the two surfaces of FIG. 1.

FIG. 3 illustrates a nanosphere manufacturing process, according to an exemplary disclosed embodiment.

### DETAILED DESCRIPTION

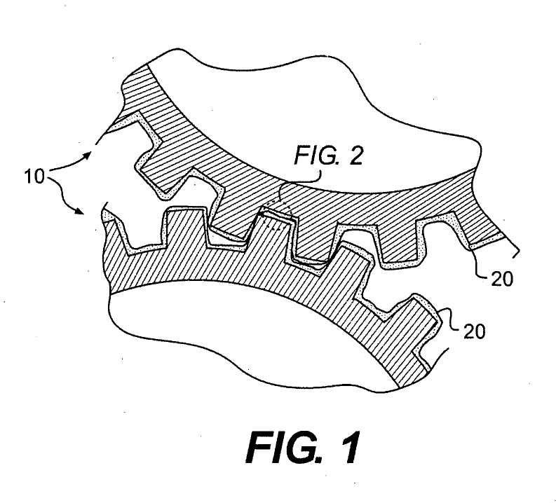

FIG. 1 illustrates two exemplary surfaces 10 moving relative to one another and a lubricant 20, wherein some frictional contact occurs between surfaces 10. Surfaces 10 may be part of a component or machine configured to perform a mechanical operation. Non limiting examples of surfaces 10 can include contacting surfaces of a piston head and a cylinder wall within an engine's combustion chamber, mating surfaces of a transmission gear assembly, hydraulics, or other opposed surfaces subject to relative movement.

Lubricant 20 can be at least partially disposed on or between surfaces 10. In some cases, lubricant 20 can reduce friction by forming a protective film on surfaces 10. In some embodiments, lubricant 20 could be added to fuels or other type of fluids. For example, lubricant 20 could be added to gasoline, diesel fuel, fuel for two-stroke engines, bio-fuels, or any other combustible fluid.

Lubricant 20 could be any liquid substance introduced between the surfaces 10 to reduce the friction or wear therebetween. In some embodiments, lubricant 20 can be composed of several different substances. Lubricant 20 can include a liquid, such as, an organic oil (e.g., vegetable oils, seed oils, and mineral oils), hydrocarbon base oils (e.g., fossil fuel based oils), synthetic liquids (e.g., hydrogenated polyolefin, esters, silicone, and fluorocarbons), or other suitable types of liquids. The composition of lubricant 20 can depend on the type of surfaces 10 being lubricated, operating conditions, expected operational life-time of mechanical components, or other parameters.

Lubricant 20 can also include a mixture of liquid and solid lubricants. In some cases, lubricant 20 may be composed entirely of a solid lubricant. In other embodiments, lubricant 20 could include a suspension of a solid lubricant in a liquid medium. Such solid lubricants may include generally spherical, sub-micron sized particulate matter, as described in detail below. In particular, solid lubricants can include hard, generally spherical, ceramic, nanometer-sized particles. In some embodiments, these solid lubricants can be treated with microwave energy to functionalize and improve physical or chemical properties associated with lubricant 20.

In addition, various additives may also be mixed with lubricant 20. One or more different additives can be configured to enhance a desirable physical or chemical characteristic of lubricant 20. For example, some additives may be configured to improve viscosity, resistance to corrosion or oxidation, wear tolerance, heat transfer, or other suitable properties.

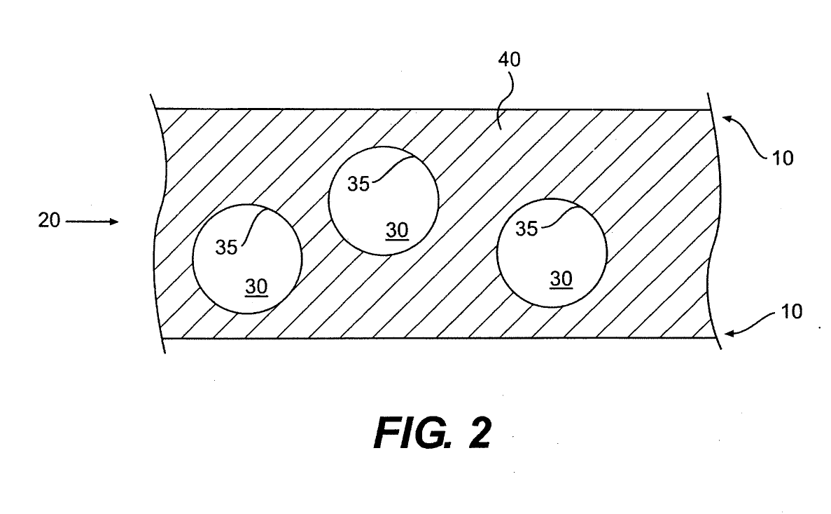

FIG. 2 illustrates an enlarged view of surfaces 10 of FIG. 1. Lubricant 20 is shown disposed between surfaces 10 and includes a plurality of nanospheres 30 within a liquid medium 40. Nanospheres 30 can include any solid lubricant, as previously described, and described in more detail below. Liquid medium 40 can include any liquid lubricant substance, as previously described, such as, organic oils, hydrocarbon-based oils, synthetic liquids, and additives. Liquid medium 40 can function to suspend nanospheres 30 in solution to at least partially prevent aggregation of nanospheres 30. Liquid medium 40 can also function as a lubrication medium in hydrodynamic or mixed lubrication types. In some cases, liquid medium 40 could operate to at least partially remove heat from surfaces 10. Also, liquid medium 40 could include a volatile liquid designed to at least partially evaporate to concentrate nanospheres 30 between surfaces 10. In yet other embodiments, liquid medium 40 may be omitted from lubricant 20.

In some embodiments, liquid medium 40 can include a chemical compound (not shown). The chemical compound can be designed to provide or enhance desirable chemical or physical properties of lubricant 20, such as, wear or corrosion resistance. For example, the chemical compound could act as a surface stabilization agent to reduce the surface energy of nanospheres 30 and reduce their tendency to aggregate. Appropriate chemical compounds can include phosphate-based, amine-based, sulphate-based, or boron-based agents. Non-limiting examples of materials that may be used as a chemical compound may include zinc dialkyl dithio phosphate (ZDDP), sodium tripolyphosphate, potassium diphosphate, and 2-ethylhexyl molybdenum dithiophosphate. As known in the art, more than one chemical compound may also be used.

Lubricant 20 can include a plurality of nanospheres 30 of any generally spherical shape. As defined herein, a nanosphere can include any generally spherical particle with a size less than about 500 nanometers. As nanospheres are generally spherical in shape, size can refer to an approximate outer diameter or an approximate width of a nanosphere. In some embodiments, nanospheres 30 could include a population having a range of sizes less than about 500 nanometers. In other embodiments, a majority of nanospheres 30 could have a size less than about 500 nanometers. In yet other embodiments, nanospheres 30 may include a population having an average size below about 200 nanometers.

Nanospheres 30 can be hard, wherein nanosphere 30 is substantially resistant to permanent deformation. Hard particles are substantially more resistant to deformation than soft particles, such as, for example, gels, or other materials with elastic or plastic deformation properties.

In some embodiments, nanospheres 30 can be formed into particles having generally uniform and closely-packed matter. In other embodiments, nanospheres 30 can be porous, whereby internal voids or cavities exist within the generally uniform structure of nanospheres 30. Further, the cavities (not shown) of nanospheres 30 can be at least partially filled with other material, such as, for example, the chemical compounds previously described. In other embodiments, the cavity surfaces of nanospheres 30 can be functionalized, as described in detail below.

Nanospheres 30 can be formed of any suitable material capable of forming a hard particle, such as, for example, a ceramic material. Such materials can include materials known in the art, materials commonly used as solid lubricants, or materials capable of forming hard, generally spherical, nano-sized particles. For example, a ceramic material could include single oxide, carbide, nitride, or inter-metallic materials. Single oxide materials can include alumina (Al₂O₃), zirconia (ZrO₂), titania (TiO₂), magnesium oxide (MgO), silica (SiO₂), mullite (3Al₂O₃. 2SiO₂), spinel (MgO.Al₂O₃), or similar material. Carbide materials can include silicon carbide (SiC), boron carbide (B₄C), titanium carbide (TiC), or similar material. Nitride materials can include boron nitride (BN), silicon nitride (Si₃N₄), or similar material. Intermetallic materials can include nickel aluminide (NiAl, Ni₃Al), titanium aluminide (TiAl, Ti₃Al), molybdenum disilicide (MoSi₂), or similar material.

In some embodiments, nanospheres 30 can include one or more sintered surfaces 35. Sintered surface 35 can include any area of nanosphere 30. For example, sintered surface 35 could include an area of nanosphere 30 extending over at least part of the circumferential area of nanosphere 30, as shown in FIG. 2. As nanospheres 30 can include internal cavities, sintered surface 35 can include one or more internal surfaces (not shown) of nanosphere 30.

Sintered surface 35 can be formed on one or more nanospheres 30 using suitable manufacturing methods, as described below in detail. Sintered surfaces 35 can provide suitable functionalization of nanospheres 30. Functionalization refers generally to a process by which chemical functional groups are bonded to a surface of nanospheres 30. As such, functionalization of nanospheres 30 can include adding chemical functional groups to at least part of the internal and/or external surfaces of nanospheres 30.

Functionalization of nanospheres 30 can provide or enhance various chemical or physical properties of lubricant 20. For example, certain functional groups may be provided to nanospheres 30 to improve stabilization, whereby the tendency of nanospheres 30 to aggregate can be partially reduced. Functional groups can further be added to nanospheres 30 to improve heat transfer, noise dampening, corrosion resistance, or other desirable properties of lubricant 20.

In some embodiments, one or more functional groups can be added to nanospheres 30. Additionally, nanospheres 30 of various size or porosity can be configured to retain variable amounts of functional groups, and hence exhibit various levels of functionalization. For example, a highly porous nanosphere 30 could be functionalized with more functional groups than a similarly sized but less porous nanosphere 30. Such variable properties can permit nanospheres 30 to be precisely tailored for certain applications, as described below.

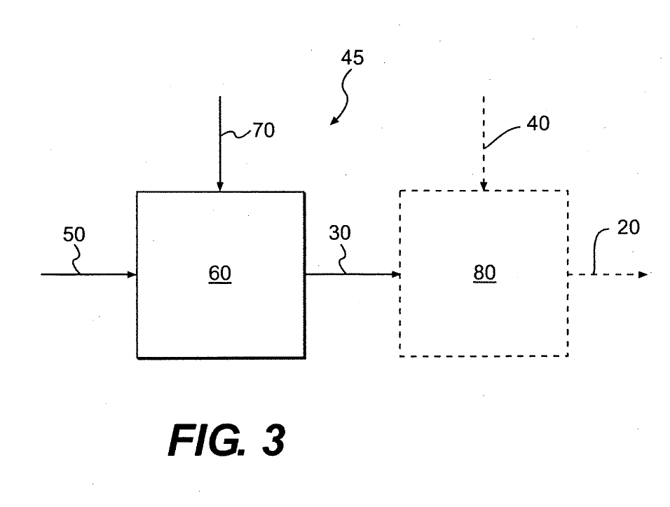

FIG. 3 illustrates a method 45 for manufacturing nanospheres 30. Untreated nanospheres 50 can be loaded into a processing chamber 60. Chamber 60 can include any device configured to treat untreated nanospheres 50 with radiation energy. In some embodiments, radiation energy can include microwave energy. For example, chamber 60 could include an Ethos 1600 device, produced by Milestone (Monroe, Conn.). Specifically, radiation energy can include primarily microwave energy, wherein the majority of the radiation is in the microwave spectrum. Microwave energy can include any energy that has a wavelength in the range of about 30 cm to about 1 mm.

In some embodiments, method 45 can use microwave energy to at least partially sinter a surface of untreated nanospheres 50. Sintering can result in bonding between a nanosphere surface and one or more select functional agents 70. The application of microwave energy, the time untreated nanospheres 50 are exposed to the microwave energy, and other parameters associated with the surface sintering process can be optimized within chamber 60. Such a process can be configured to provide sufficient heat to the nanosphere surface. Heat can be required to overcome activation energies of the reactants and trigger a bonding reaction on the nanosphere surface. For example, chamber 60 could heat reactants to 150° C. for 10 min, or 200° C. for 20 to 60 min, or 250° C. for 30 to 60 min, depending upon the extent of surface reaction required. The functional group of functional agent 70 can thus be bonded to the nanosphere surface, leading to functionalization of the resulting nanospheres 30. Further, one or more reactants formed within chamber 60 may also bond to nanospheres 30 to provide some functionalization. Nanospheres 30 can be controllably produced for specific applications in various tribology and lubrication applications.

Chamber 60 can also be configured to combine untreated nanospheres 50 with one or more functional agents 70. Functional agents 70 can include a compound including one or more functional groups that can be reacted with untreated nanospheres 50 to form functionalized nanospheres 30, as described above. Functional agents 70 can be used to functionalize untreated nanospheres 50 to enhance one or more of corrosion inhibition, rust inhibition, pressure, wear or other characteristic of nanospheres 30. For example, functional agents 70 can include one or more of metal dithiophosphates, metal dithiocarbamates, metal sulfonates, thiadiazoles, sulfurized terpenes, metal sulfonates, alkylamines, alkyl amine phosphates, alkenylsuccinic acids, fatty acids, acid phosphate esters, alkyl sulfides, polysulfides, sulfurized fatty oils, chlorinated fatty oils, chlorinated paraffinic waxes, alkyl phosphites, alkyl phosphates, ashless dithiophosphates, carboxylates, metal triborates, chlorinated waxes, lead naphthenate, or combinations thereof. Functional agent 70 can be a solid, liquid, gaseous, or a gelatinous type material.

In some embodiments, commercially available untreated nanospheres 50 may be combined with one or more functional agents 70 within chamber 60. This mixture may be subjected to one or more heating and/or cooling steps before, after, or during treatment of the mixture with radiation energy. It is also contemplated that processing may be conducted with continuous or intermittent stirring or mixing of the untreated nanospheres 50 and functional agents 70.

In another embodiment, chamber 60 can include multiple compartments configured to treat the nanospheres such that nanosphere manufacturing may occur in multiple stages. For example, a first chamber (not shown) could be configured to expose untreated nanospheres 50 to radiation energy under a select condition. The nanospheres may then be exposed to one or more functional agents 70 and selectively heated for certain times. Monitoring, sampling, or other quality control techniques could be used to ensure suitable production of nanospheres 30. For example, various filters (not shown) could be used to ensure nanospheres 30 are generally consistent in size.

In some embodiments, all or substantially all of lubricant 20 can be nanospheres 30. For example, if a generally solid lubricant is desired, nanospheres 30 output from chamber 60 may be used as lubricant 20. In other embodiments where a liquid lubricant is desired, lubricant 20 may be formed by nanospheres 30 and liquid medium 40.

Method 45 may optionally include mixing nanospheres 30 produced from chamber 60 with liquid medium 40 in a mixing machine 80 to produce lubricant 20. Mixing machine 80 can include any suitable device configured to combine nanospheres 30 and liquid medium 40. For example, mixing machine 80 may include a mechanical mixer, an ultrasonic mixer, or any other mixer known in the art.

Liquid medium 40 may include any organic oil, a hydrocarbon based oil, or a synthetic liquid as previously described. Various additives (not shown) may be also be mixed with liquid medium 40. These additives may enhance one or more desirable properties of lubricant 20. For example, the additives may function to protect surfaces 10 from rust and/or wear, enhance the properties of lubricant 20 for specific applications, and protect lubricant 20 from oxidizing. These additives may include acid neutralizers, antifoam agents, antioxidants, antirust agents, corrosion inhibitors, detergents, dispersants, emulsifiers, extreme pressure additives, oiliness enhancers, pour point depressants, tackiness agents, viscosity index improvers, and/or any other lubricant additives known in the art.

In some embodiments, lubricant 20 can be further subjected to various manufacturing processes (not shown). For example, a monitoring process may be applied to measure various physical and/or chemical characteristics, such as viscosity, nanosphere loading, lubricity, etc., of lubricant 20. In some embodiments, some of lubricant 20 could be routed back to chamber 60, or another processing step, for further processing based on output from a monitoring process. Another process could include a purification process whereby contaminants and other undesirable materials could be removed from lubricant 20. Such a process could include filtering out various sized nanoparticles 30 of undesirable size or property.

### INDUSTRIAL APPLICABILITY

Nanospheres 30 can be added to lubricants, fuels, other fluid media, or combinations thereof. As previously described, lubricant 20 can be used to reduce the friction or wear between any moving parts. Lubricant 20 can contain hard nanospheres 30 that can function to at least partially maintain the separation of surfaces 10 of various moving parts. Nanospheres 30 may also reduce friction between surfaces 10 by acting as “balls” in a “ball bearing” interface between surfaces 10. The tribology properties of lubricant 20 can also be enhanced by novel properties of nanospheres 30 that arise from their dimensions and/or functionalized surfaces.

Various fluids can include nanospheres 30 as described herein, wherein nanospheres 30 can include one or more functional groups. Functional groups can include compounds configured to impart or enhance various desirable properties of such fluids. For example, functional groups may enhance wear or friction properties, heat transfer, corrosion resistance, reduce emission levels, noise dampening, or other properties of lubricant 20. In particular, these functional groups may function as surface stabilization agents to reduce the tendency of nanospheres 30 to aggregate.

Nanospheres 30 can have sintered surfaces 35 that include one or more of these various functional groups. Sintering can include the treatment of nanospheres with radiation energy, and in particular, microwave energy. Microwave energy applied to a mixture of functional agents 70 and untreated nanospheres 50 can result in a sintered surface whereby functional groups are bonded to internal or external surfaces of nanospheres 30. The manufacturing process can be controlled and modified to form nanospheres 30 with one or more types of various levels of functional groups. The presence of differing amounts of suitably formed nanospheres 30 can impart or enhance various physical or chemical properties of lubricant 20.

It will be apparent to those skilled in the art that various modifications and variations can be made to the disclosed nanospheres 30, or lubricant 20. Other embodiments will be apparent to those skilled in the art from consideration of the specification and practice of the disclosed nanospheres 30, or lubricant 20. It is intended that the specification and examples be considered as exemplary only, with a true scope being indicated by the following claims and their equivalents.

What is claimed is:

1. A method of manufacturing a lubricant comprising;
providing a hard nanosphere having a size of less than about 500 nanometers; and
exposing the nanosphere to a radiation energy to at least partially bond a functional agent to a surface of the nanosphere.

2. The method of claim 1, wherein the radiation energy includes microwave energy.

3. The method of claim 2, wherein the microwave energy has a wavelength in the range of about 30 cm to about 1 mm.

4. The method of claim 1, wherein the nanosphere includes a ceramic material.

5. The method of claim 4, wherein the ceramic material includes at least one of a single oxide, a carbide, a nitride, and an intermetallic.

6. The method of claim 5, wherein the single oxide includes at least one of alumina, zirconia, titania, magnesium oxide, silica, mullite, and spinel.

7. The method of claim 5, wherein the carbide includes at least one of silicon carbide, boron carbide, and titanium carbide.

8. The method of claim 5, wherein the nitride includes at least one of boron nitride and silicon nitride.

9. The method of claim 5, wherein the intermetallic includes at least one of nickel aluminide, titanium aluminide, and molybdenum disilicide.

10. The method of claim 1, wherein the functional agent includes at least one material selected from a metal dithiophosphate, a metal dithiocarbamate, a metal sulfonate, a thiadiazole, a sulfurized terpene, an alkylamine, an alkyl amine phosphate, an alkenylsuccinic acid, a fatty acid, an acid phosphate ester, an alkyl sulfide, a polysulfide, a sulfurized fatty oil, a chlorinated fatty oil, a chlorinated paraffmic wax, an alkyl phosphite, an alkyl phosphate, an ashless dithiophosphate, a carboxylate, a metal triborate, a chlorinated wax, and a lead naphthenate.

11. The method of claim 1, further including mixing the nanosphere with a fluid, wherein the fluid includes at least one of a base oil and a fuel.

12. The method of claim 11, further including mixing the nanosphere with an additive.

13. A lubricant comprising;
a hard nanosphere having a dimension of less than about 500 nanometers; and
a functional agent at least partially bonded to a surface of the nanosphere by radiation energy.

14. The lubricant of claim 13, wherein radiation energy includes microwave energy.

15. The lubricant of claim 13, wherein the nanosphere includes a ceramic material.

16. The lubricant of claim 15, wherein the ceramic material includes at least one of a single oxide, a carbide, a nitride, and an intermetallic.

17. The lubricant of claim 13, further including a fluid, wherein the fluid includes at least one of a base oil and a fuel.

18. A lubricant comprising;
a base oil;
a lubricant additive; and
a ceramic nanosphere having a size less than about 500 nanometers and a functional agent at least partially bonded to a surface of the nanosphere by microwave energy.

19. The lubricant of claim 18, wherein the base oil includes at least one of an organic oil, a hydrocarbon based oil, and a synthetic liquid.

20. The lubricant of claim 18, wherein the lubricant additive includes an acid neutralizer, an antifoam agent, an antioxidant, an antirust agent, a corrosion inhibitor, a detergent, a dispersant, an emulsifier, an extreme pressure additive, an oiliness enhancer, a pour point depressant, a tackiness agent, and a viscosity index improver.
